(19) United States
(12) Patent Application Publication
(10) Pub. No.: US 2018/0302113 A1
(43) Pub. Date: Oct. 18, 2018

(54) DISTORTION CANCELLATION APPARATUS AND DISTORTION CANCELLATION METHOD

(71) Applicant: FUJITSU LIMITED, Kawasaki-shi (JP)

(72) Inventors: Satoshi Matsubara, Kawasaki (JP); Yusuke Tobisu, Yokohama (JP); Hisato Kawano, Kawasaki (JP); Hideyuki Kannari, Yokohama (JP)

(73) Assignee: FUJITSU LIMITED, Kawasaki-shi (JP)

(21) Appl. No.: 15/944,424

(22) Filed: Apr. 3, 2018

(30) Foreign Application Priority Data
Apr. 18, 2017 (JP) 2017-082283

(51) Int. Cl. H04B 1/12

(52) U.S. Cl. CPC H04B 1/12

(57) ABSTRACT

There is provided a distortion cancellation apparatus including a memory, and a processor coupled to the memory and the processor configured to acquire transmission signals to be wirelessly transmitted at different frequencies, acquire a received signal to which intermodulation signals generated by the transmission signals are added, generate cancellation signals respectively corresponding to the intermodulation signals added to the received signal by using an arithmetic expression including the transmission signals and the received signal, calculate an influence rate indicating a magnitude of a signal level of each of the intermodulation signals within a band of the received signal, and first cancel an intermodulation signal out of the intermodulation signals added to the received signal wherein the influence rate of the intermodulation signal first canceled is high out of the intermodulation signals added to the received signal, based on the cancellation signals.

### CROSS-REFERENCE TO RELATED APPLICATION

This application is based upon and claims the benefit of priority of the prior Japanese Patent Application No. 2017-082283, filed on Apr. 18, 2017, the entire contents of which are incorporated herein by reference.

### FIELD

The embodiments discussed herein are related to a distortion cancellation apparatus and a distortion cancellation method.

### BACKGROUND

Recently, for the purpose of improving the throughput in a wireless communication system, technologies such as, for example, carrier aggregation and multi-input multi-output (MIMO) have been introduced. Carrier aggregation is a technology in which a base station device and a wireless terminal device communicate with each other by using a plurality of carriers of different frequencies. MIMO is a technology in which the transmitter side transmits different pieces of data from a plurality of transmitting antennas, respectively, and the receiver side separates a combined wave to which data transmitted from each transmitting antenna are combined, based on received signals at the plurality of receiving antennas.

Owing to introduction of these technologies, a variety of signals of different frequencies are transmitted inside or outside wireless communication devices, such as a base station device and a wireless terminal device. If a distortion source, for example, metal or the like, is present in the transmission path of the signals, intermodulation of signals of different frequencies generates an intermodulation signal. That is, an intermodulation signal having a frequency which is a sum or difference of multiples of the frequencies of the respective signals is generated in a distortion source. If the frequency of an intermodulation signal is included in the reception frequency band of a wireless communication device, an intermodulation signal hinders demodulation and decoding of received signals, resulting in a decrease in the receiving quality.

To suppress such a decrease in the receiving quality caused by an intermodulation signal, there are discussed techniques, such as approximately reconstructing an intermodulation signal generated by intermodulation, for example, between a transmission signal transmitted from a wireless communication device and an interfering signal transmitted from another wireless communication device to cancel an intermodulation signal included in a received signal.

An intermodulation signal (hereinafter referred to as an IM signal) generated from a plurality of signals with different frequencies may be reproduced by an arithmetic operation. For example, it is assumed that the frequency bandwidth of long term evolution (LTE) is 10 MHz, the center frequencies of transmission signals Tx1 and Tx2 are f1=1539 MHz and f2=1523 MHz, respectively. In this case, third-order intermodulation distortions occur at the center frequencies/bandwidths given below. However, the execution bandwidth in LTE is assumed to be 0.9 times the above-mentioned frequency bandwidth. In this case, the execution bandwidth is assumed to be 9 MHz.

1539 MHz/27 MHz

1523 MHz/27 MHz

1507 MHz/27 MHz

1555 MHz/27 MHz

1539 MHz/27 MHz

1523 MHz/27 MHz

These are values calculated by the following calculation formulas.

1539 [MHz]=f1*f1*conj(f1)

1523 [MHz]=f1*f2*conj(f1)

1507 [MHz]=f2*f2*conj(f1)

1555 [MHz]=f1*f1*conj(f2)

1539 [MHz]=f1*f2*conj(f2)

1523 [MHz]=f2*f2*conj(f2)

That is, assuming that the center frequency of a received signal Rx is 1509 MHz, third-order intermodulation distortions of f1*f2*conj(f1), f2*f2*conj(f1), and f2*f2*conj(f2) overlap the reception band, causing passive intermodulation (PIM).

FIG. 10 is a diagram illustrating an example of the center frequency, the minimum frequency, and the maximum frequency of each third-order intermodulation signal, the bandwidth of an IM signal, the presence or absence of occurrence of PIM, and the detuning frequency. The detuning frequency represents the frequency of a difference from the center frequency of a received signal Rx to the center frequency of a third-order intermodulation distortion signal (IM signal).

FIG. 11 is a diagram illustrating an example of the relationship between the detuning frequency and the signal level (power) of an IM signal. As illustrated in FIG. 11, typically, the signal level of an IM signal increases as the center frequency of the IM signal is approached and decreases with distance from the center frequency of the IM signal.

FIG. 12 is a diagram illustrating an example of the relationship between the signal level of an IM signal and the convergence time (elapsed time) taken until convergence of the signal level thereof. A curve L1 represents the relationship between the signal level of an IM signal and the convergence time when PIM distant from the center frequency of the received signal Rx is first cancelled. A curve L2 represents the relationship between the signal level of an IM signal and the convergence time when PIM close to the center frequency of the received signal Rx is first cancelled.

As described above, the signal level of an IM signal increases as the center frequency of the IM signal is approached and decreases with distance from the center frequency of the IM signal. That is, PIM close to the center frequency of the received signal Rx has a stronger influence. Accordingly, if PIM distant from the center frequency of the received signal Rx is first cancelled (refer to the curve L1 in FIG. 12), its cancellation effect is unlikely to be recognized compared with the case where PIM close to the center frequency of the received signal Rx is first cancelled (refer to the curve L2 in FIG. 12).

Therefore, even if both the cases are ultimately the same in terms of the convergence time taken until convergence of the signal level of an IM signal, a difference occurs during the process to the convergence. For example, when PIM distant from the center frequency of the received signal Rx is first cancelled, a specification stating that the signal level of an IM signal be decreased to a set level by a set time is not satisfied in some cases.

The problem mentioned above arises in some cases, and therefore it is preferable that, when performing the processes, the process in which PIM close to the center frequency of the received signal Rx is cancelled first have priority over the process in which PIM distant from the center frequency of the received signal Rx is cancelled first.

Japanese National Publication of International Patent Application No. 2009-526442 is an example of the related art.

### SUMMARY

According to an aspect of the invention, a distortion cancellation apparatus includes a memory, and a processor coupled to the memory and the processor configured to acquire a plurality of transmission signals to be wirelessly transmitted at different frequencies, acquire a received signal to which a plurality of intermodulation signals generated by the plurality of transmission signals are added, generate a plurality of cancellation signals respectively corresponding to the plurality of intermodulation signals added to the received signal by using an arithmetic expression including the plurality of transmission signals and the received signal, calculate an influence rate indicating a magnitude of a signal level of each of the plurality of intermodulation signals within a band of the received signal, and first cancel an intermodulation signal out of the plurality of intermodulation signals added to the received signal wherein the influence rate of the intermodulation signal first canceled is high out of the plurality of intermodulation signals added to the received signal, based on the plurality of cancellation signals.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a wireless communication system according to a first embodiment;

FIG. 2 is a diagram illustrating a concept of embodiments;

FIG. 3 is a diagram illustrating a concept of embodiments;

FIG. 4 is a diagram illustrating a concept of embodiments;

FIG. 5 is a block diagram illustrating an example of functions of a processor of a cancellation apparatus of a wireless communication system according to the first embodiment;

FIG. 6 is a diagram illustrating an example of the center frequency, the minimum frequency, and the maximum frequency of each third-order intermodulation distortion, the presence or absence of occurrence of PIM, the bandwidth of an IM signal, the detuning frequency, the influence rate, and the order of priority in a wireless communication system according to the first embodiment;

FIG. 7 is a flowchart illustrating an example of a distortion cancellation process of a wireless communication system according to the first embodiment;

FIG. 8 is a diagram illustrating an example of the center frequency, the minimum frequency, and the maximum frequency of each third-order intermodulation distortion, the present or absence of occurrence of PIM, the bandwidth of an IM signal, the detuning frequency, the influence rate, and the order of priority in a wireless communication system according to a second embodiment;

FIG. 9 is a flowchart illustrating an example of a distortion cancellation process of a wireless communication system according to the second embodiment;

FIG. 10 is a diagram illustrating an example of the center frequency, the minimum frequency, and the maximum frequency of each third-order intermodulation distortion, the bandwidth of an IM signal, the presence or absence of occurrence of PIM, and the detuning frequency;

FIG. 11 is a diagram illustrating an example of the relationship between the detuning frequency and the signal level (power) of an IM signal;

FIG. 12 is a diagram illustrating an example of the relationship between the signal level of an IM signal and the convergence time (elapsed time) taken until convergence of the signal level thereof;

FIG. 13 is a diagram illustrating an example of detuning frequencies between a received signal (“Rx”) and IM signals with bandwidths of 36 MHz and 54 MHz; and

FIG. 14 is a diagram illustrating an example of the detuning frequencies between a received signal (“Rx”) and IM signals with bandwidths of 36 MHz and 54 MHz.

### DESCRIPTION OF EMBODIMENTS

In the foregoing example, since the determination is made simply by using the detuning frequencies between the center frequency of the received signal Rx and the center frequencies of IM signals, such a problem as described below arises when the bandwidths of transmission signals are different.

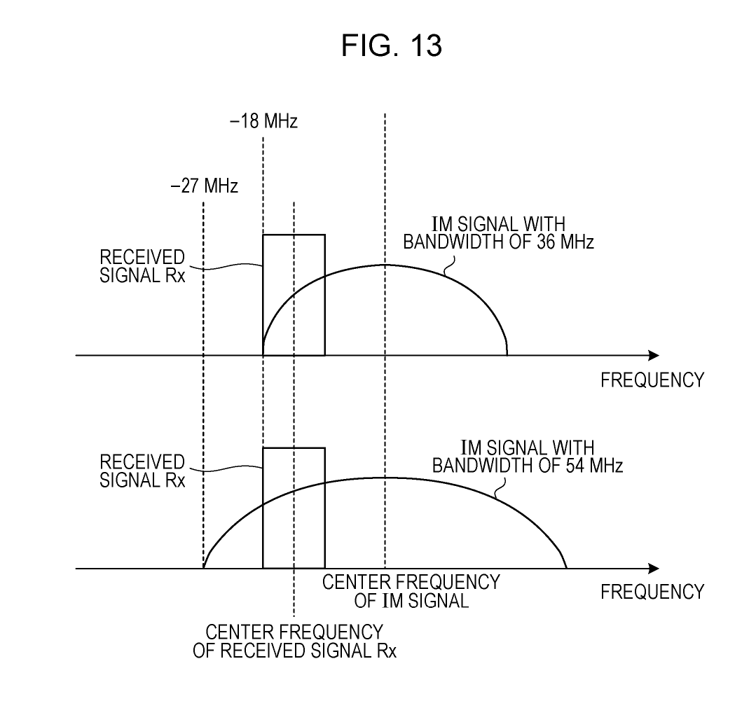

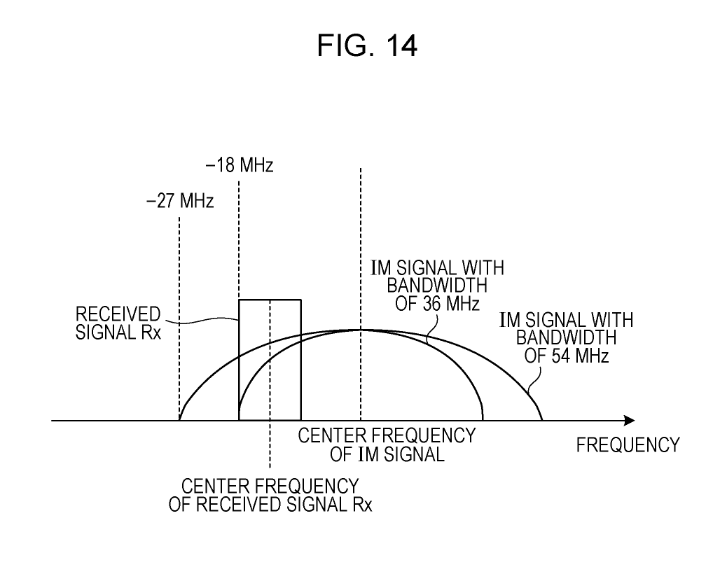

FIG. 13 and FIG. 14 are diagrams illustrating an example of detuning frequencies between the received signal Rx and IM signals with bandwidths of 36 MHz and 54 MHz. As illustrated in FIG. 13 and FIG. 14, the detuning frequency with respect to the center frequency of the received signal Rx is the same between the IM signal with a bandwidth of 36 MHz and the IM signal with a bandwidth of 54 MHz; however, the IM signal of 54 MHz is larger in terms of the influence of PIM. Therefore, it is not possible to make a determination simply by using the detuning frequencies between the center frequency of the received signal Rx and the center frequencies of IM signals. That is, it becomes unclear which PIM is to be cancelled at the highest priority among plural pieces of PIM. As a result, a problem arises in that the processing time for cancelling PIM is increased.

Hereinafter, embodiments of a distortion cancellation apparatus and a distortion cancellation method disclosed in the present application will be described in detail with reference to the accompanying drawings. Note that the present disclosure is not limited by embodiments described below.

### First Embodiment

Configuration of Wireless Communication System

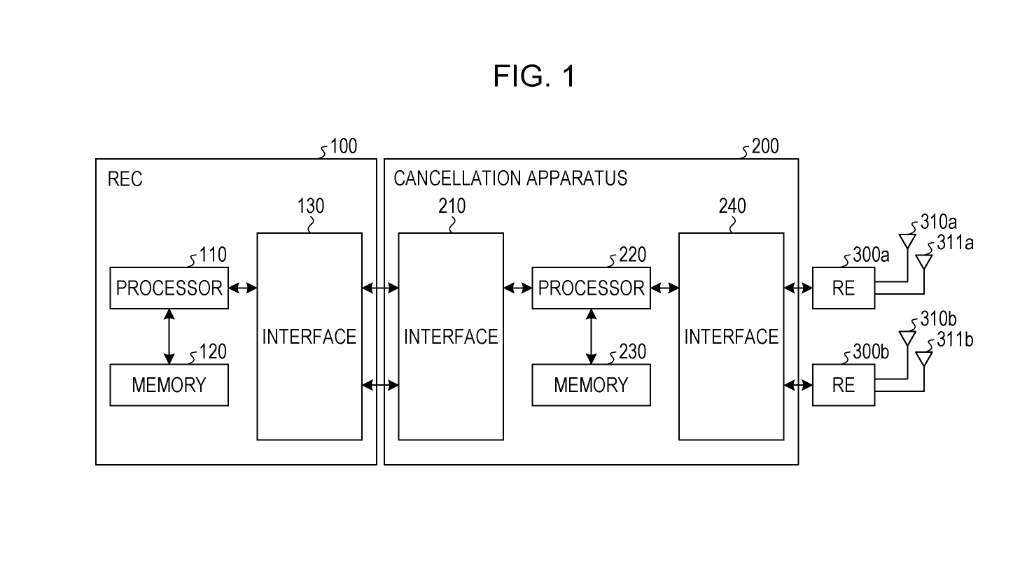

FIG. 1 is a block diagram illustrating an example of a configuration of a wireless communication system according to a first embodiment. The wireless communication system according to the first embodiment includes a radio equipment control (REC) 100, a cancellation apparatus 200, and radio equipments (REs) 300a and 300b. Note that the two REs 300a and 300b are illustrated in FIG. 1; however, one RE or three or more REs may be coupled to the cancellation apparatus 200. In addition, one REC is illustrated; however, two or more RECs may be coupled to the cancellation apparatus 200.

The REC 100 performs baseband processing and transmits a baseband signal including transmission data to the cancellation apparatus 200. In addition, the REC 100 receives a baseband signal including received data from the cancellation apparatus 200 and applies baseband processing to this baseband signal. Specifically, the REC 100 includes a processor 110, a memory 120, and an interface 130.

The processor 110, including, for example, a central processing unit (CPU), a field programmable gate array (FPGA), a digital signal processor (DSP), or the like, generates a transmission signal to be transmitted from each of the REs 300a and 300b. In the present embodiment, the case where the RE 300a transmits transmission signals at frequencies f1 and f2 different from each other from two antennas 300a and 311a, respectively, and the RE 300b transmits transmission signals at frequencies f3 and f4 different from each other from two antennas 310b and 311b, respectively, will be described by way of example. Therefore, the processor 110 generates transmission signals Tx1 and Tx2 to be transmitted from the two antennas 310a and 311a of the RE 300a, respectively, and transmission signals Tx3 and Tx4 to be transmitted from the two antennas 310b and 311b of the RE 300b, respectively. In addition, the processor 110 acquires received data from received signals received by the REs 300a and 300b.

The memory 120, including, for example, random access memory (RAM), read only memory (ROM), or the like, stores therein information to be used for the processor 110 to execute a process.

The interface 130, coupled to the cancellation apparatus 200 by, for example, an optical fiber and the like, transmits and receives baseband signals to and from the cancellation apparatus 200. The transmission signals Tx1, Tx2, Tx3, and Tx4 mentioned above are included in the baseband signals transmitted by the interface 130.

The cancellation apparatus 200, coupled between the REC 100 and the REs 300a and 300b, relays baseband signals transmitted and received between the REC 100 and the REs 300a and 300b. In addition, the cancellation apparatus 200 generates cancellation signals corresponding to intermodulation signals, based on the transmission signals Tx1, Tx2, Tx3, and Tx4, and combines the cancellation signals with a received signal.

Note that the high-order distortion (for example, third-order distortion) of an intermodulation signal or the like occurs from a single transmission signal, for example, the transmission signal Tx1 in some cases and occurs from a plurality of transmission signals, for example, the transmission signal Tx1 and the transmission signal Tx2 of different frequencies in other cases. In the present embodiment, it is assumed that, as a high-order distortion, an intermodulation signal is generated by irradiating a distortion source with the transmission signals Tx1 and Tx2, and the intermodulation signal has a frequency included in the reception frequency bands of the REs 300a and 300b. That is, the cancellation apparatus 200 cancels an intermodulation signal generated by intermodulation of the transmission signals Tx1 and Tx2.

The cancellation apparatus 200 includes interfaces 210 and 240, a processor 220, and a memory 230.

The interface 210, coupled to the REC 100, transmits and receives baseband signals to and from the REC 100. That is, the interface 210 receives transmission signals generated by the processor 110 from the interface 130 of the REC 100. The interface 210 also transmits received signals received by the REs 300a and 300b to the interface 130 of the REC 100.

The processor 220, including, for example, a CPU, a FPGA, a DSP, or the like, generates a cancellation signal for cancelling an intermodulation signal, based on a plurality of transmission signals received by the interface 210. In addition, the processor 220 combines the cancellation signal with a received signal received by the interface 240 and cancels an intermodulation signal added to the received signal. The functions of the processor 220 will be described later in more detail.

The memory 230, including, for example, RAM, ROM, or the like, stores therein information used for the processor 220 to execute a process. That is, the memory 230 stores therein, for example, parameters and the like used when the processor 220 generates a cancellation signal.

The interface 240, coupled to the REs 300a and 300b by, for example, an optical fiber and the like, transmits and receives baseband signals to and from the REs 300a and 300b. That is, the interface 240 transmits transmission signals received from the REC 100 to the REs 300a and 300b. The interface 240 also receives received signals received by the REs 300a and 300b from the REs 300a and 300b. Intermodulation signals generated by intermodulation of a signal of the frequency f1 and a signal of the frequency f2 are added to the received signals that the interface 240 receives from the REs 300a and 300b.

The REs 300a and 300b up-convert baseband signals received from the cancellation apparatus 200 to the wireless frequencies f1 to f4, respectively, and transmit the frequencies via antennas. That is, the RE 300a up-converts the transmission signals Tx1 and Tx2 to the frequencies f1 and f2, respectively, and transmits the frequencies from the antennas 310a and 311a. The RE 300b up-converts the transmission signals Tx3 and Tx4 to the frequencies f3 and f4, respectively, and transmits the frequencies from the antennas 310b and 311b. The REs 300a and 300b also down-convert received signals received via antennas to baseband frequencies and transmit the frequencies to the cancellation apparatus 200. The above-mentioned intermodulation signals generated by intermodulation of signals of the frequencies f1 and f2 are added to the received signals that are received by the REs 300a and 300b.

Cancellation Signals

As described above, the processor 220 of the cancellation apparatus 200 generates a cancellation signal for an intermodulation signal generated by intermodulation of the transmission signals Tx1 and Tx2. The cancellation signal is a replica of an intermodulation signal generated by using a plurality of transmission signals, and, for example, a cancellation equation (1) given below may be used for generation thereof. However, equation (1) is an equation by which when frequencies (f1+f2−f1), (2f2−f1), and (2f2−f2) are included in a reception frequency band, a cancellation signal C that cancels a third-order distortion in this reception frequency band is generated.

$$C = p 1 \cdot Tx 1 \cdot Tx 2 \cdot conj ( Tx 1 ) + p 2 \cdot Tx 2 \cdot Tx 2 \cdot conj ( Tx 1 ) + p 3 \cdot Tx 3 \cdot Tx 2 \cdot conj ( Tx 2 ) \qquad ( 1 )$$

In equation (1), p1 to p3 are given coefficients, and conj(x) denotes a conjugate complex of x. Cancellation equation (1) includes three coefficients, p1 to p3. When a cancellation signal C is calculated by cancellation equation (1), these three coefficients are obtained before calculation of the cancellation signal C.

Up to third-order intermodulation signals are taken into consideration here; however, a higher-order intermodulation signal, such as a fifth-order or seventh-order intermodulation signal, may be added to the above equation (1).

### Concept of Embodiments of Present Disclosure

In embodiments of the present disclosure, an IM signal where the influence rate of PIM on a received signal Rx is high is cancelled first. The influence rate indicates the magnitude of a signal level of each of intermodulation signals (hereinafter referred to as IM signals) within the band of a received signal Rx (for example, refer to FIG. 13 and FIG. 14). Thus, in embodiments of the present disclosure, the processing time taken to cancel PIM may be improved.

Here, assuming that the influence rate is IR, equation (2) given below, for example, may be used for the influence rate IR (%).

IR={(B_{IM}+B_{RX})/2−abs(f_{Rx}−f_{IM})}/{(B_{IM}+B_{RX})/2} (2)

In equation (2), B_{IM} denotes the bandwidth of an IM signal and B_{RX} denotes the bandwidth of a received signal Rx. In addition, f_{RX} denotes the center frequency of the received signal Rx and f_{IM} denotes the center frequency of the IM signal.

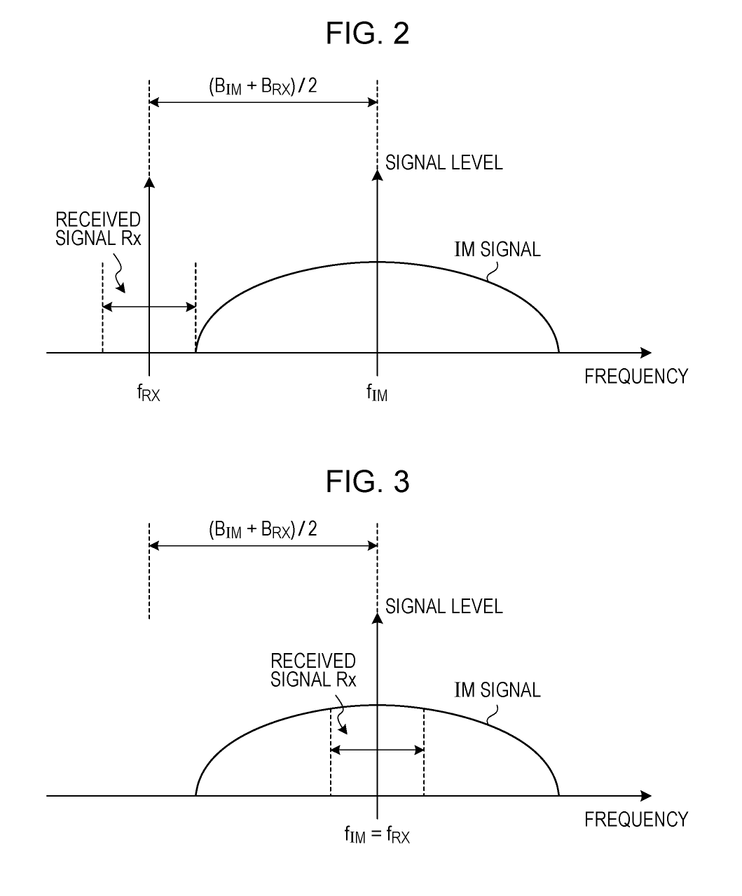

Note that when (B_{IM}+B_{RX})/2−abs (f_{RX}−f_{IM})≤0, the meaning is that the received signal Rx and the IM signal do not overlap each other. FIGS. 2 to 4 are diagrams illustrating a concept of embodiments.

For example, as illustrated in FIG. 2, when the minimum frequency of the IM signal is the same as the maximum frequency of the received signal Rx, the influence rate IR is 0%.

For example, as illustrated in FIG. 3, the center frequency of the IM signal is the same as the center frequency of the received signal Rx (f_{IM}=f_{Rx}), the influence rate IR is 100%.

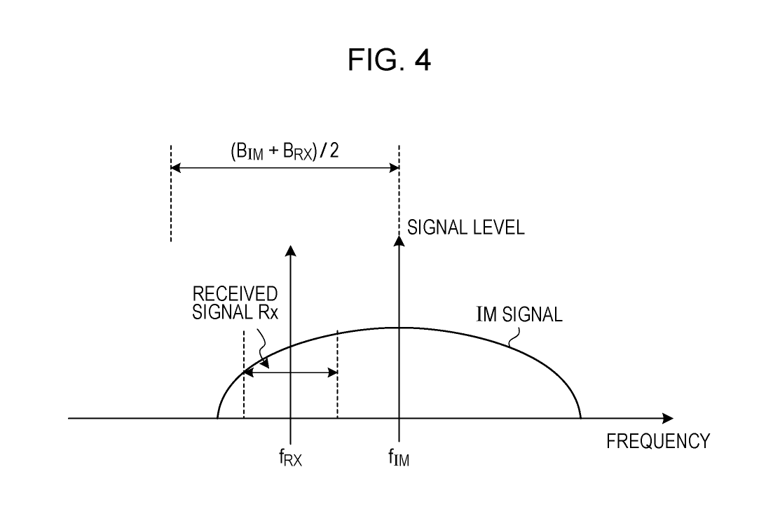

For example, as illustrated in FIG. 4, when the center frequency of the IM signal is the same as a value obtained by adding the center frequency of the received signal Rx to a value obtained by dividing a sum of the bandwidth of the IM signal and the bandwidth of the received signal Rx by four (f_{IM}=f_{RX}+(B_{IM}+B_{RX})/4), the influence rate IR is 50%.

Functional Configuration of Cancellation Apparatus

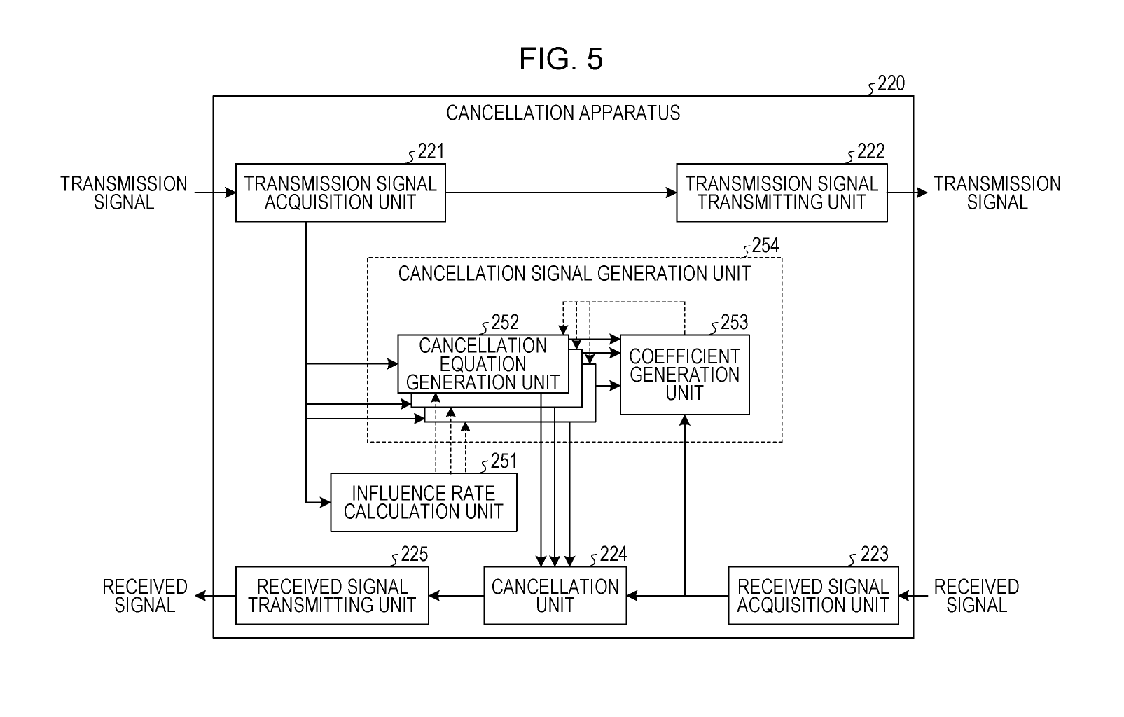

FIG. 5 is a block diagram illustrating an example of functions of the processor 220 of the cancellation apparatus 200 of a wireless communication system according to the first embodiment. The processor 220 includes a transmission signal acquisition unit 221, a transmission signal transmitting unit 222, a received signal acquisition unit 223, a cancellation unit 224, a received signal transmitting unit 225, an influence rate calculation unit 251, and a cancellation signal generation unit 254. The cancellation signal generation unit 254 includes cancellation equation generation units 252 and a coefficient generation unit 253.

The transmission signal acquisition unit 221 acquires transmission signals received from the REC 100 by the interface 210. That is, the transmission signal acquisition unit 221 acquires the transmission signals Tx1, Tx2, TX3, and TX4.

The transmission signal transmitting unit 222 transmits the transmission signals acquired by the transmission signal acquisition unit 221 via the interface 240 to the REs 300a and 300b. Specifically, the transmission signal transmitting unit 222 transmits the transmission signals Tx1 and Tx2 to the RE 300a and transmits the transmission signals Tx3 and Tx4 to the RE 300b.

The received signal acquisition unit 223 acquires received signals received from the REs 300a and 300b by the interface 240. IM signals generated by intermodulation of the transmission signals Tx1 and Tx2 are added to the received signals that are acquired by the receiving signal acquisition unit 223.

The cancellation unit 224 combines a cancellation signal C generated by using a cancellation equation by the cancellation equation generation unit 252 of the cancellation signal generation unit 254 with the received signal. That is, the cancellation unit 224 combines (adds) the cancellation signal C with the received signal to which an IM signal is added, thereby cancelling the IM signal.

The received signal transmitting unit 225 transmits the received signal resulting after the IM signal has been cancelled, via the interface 210 to the REC 100.

The influence rate calculation unit 251 calculates a plurality of IM signals from the transmission signals Tx1 and Tx2 acquired by the transmission signal acquisition unit 221. The influence rate calculation unit 251 calculates the influence rate IR indicating the magnitude of the signal level of each of the plurality of IM signals within the band of the received signal Rx. That is, the influence rate calculation unit 251 calculates the influence rate IR of PIM on the received signal Rx. The influence rate IR is calculated by the above equation (2). Based on the influence rate IR, the influence rate calculation unit 251 sets a combination of the transmission signals Tx1 and Tx2 for generating a plurality of IM signals that overlap the received signal Rx in the cancellation equation generation units 252 of the cancellation signal generation unit 254.

In the cancellation signal generation unit 254, each cancellation equation generation unit 252 in which the setting has been performed by the influence rate calculation unit 251 generates IM signals from the transmission signals Tx1 and Tx2 acquired by the transmission signal acquisition unit 221. Each cancellation equation generation unit 252 then generates cancellation equations for generating cancellation signals C from the IM signals. Specifically, upon coefficients for cancellation equations being determined by the coefficient generation unit 253, each cancellation equation generation unit 252 generates the following equations (3) to (5) included in the above equation (1) as equations of cancellation signals C.

C=p1·Tx1·Tx2·conj(Tx1) (3)

C=p2·Tx2·Tx2·conj(Tx1) (4)

C=p3·Tx2·Tx2·conj(Tx2) (5)

Thus, a plurality of cancellation signals C respectively corresponding to a plurality of IM signals are generated by a plurality of cancellation equation generation units 252. As a result, based on the plurality of cancellation signals C, an IM signal with a high influence rate IR out of the plurality of IM signals added to the received signal Rx is cancelled first by the cancellation unit 224.

In the cancellation signal generation unit 254, the coefficient generation unit 253 determines coefficients included in a cancellation equation by, for example, a least mean square (LMS) algorithm, a lest-square method, or the like. That is, the coefficient generation unit 253 determines the coefficients p1 to p3 respectively included in the above equations (3) to (5) by, for example, an LMS algorithm using the received signal Rx, or the like. In addition, the coefficient generation unit 253 may determine, for example, the coefficients p1 to p3 that maximize the correlation between the cancellation signals and the received signal Rx. The coefficient generation unit 253 then notifies each cancellation equation generation unit 252 of the determined coefficients p1 to p3.

Note that the coefficient generation unit 253 is provided common to all the cancellation equation generation units 252 in the present embodiment, but may be provided for each cancellation equation generation unit 252.

### Specification Examples

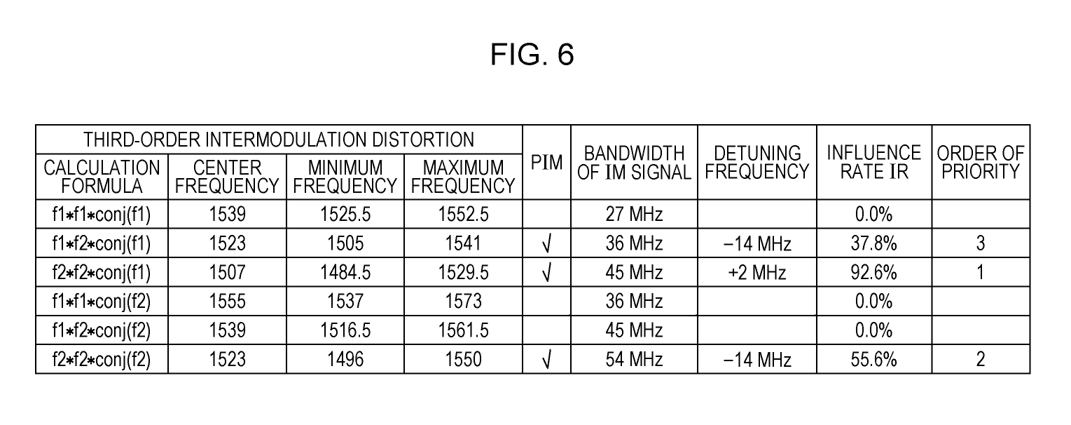

Here, the influence rate IR and the order of priority will be described with reference to a specific example. FIG. 6 is a diagram illustrating an example of the center frequency, the minimum frequency, and the maximum frequency of each third-order intermodulation distortion, the presence or absence of occurrence of PIM, the bandwidth of an IM signal, the detuning frequency, the influence rate IR, and the order of priority in a wireless communication system according to the first embodiment. The detuning frequency represents the frequency of a difference from the center frequency of the received signal Rx to the center frequency of the IM signal.

For example, in LTE, it is assumed that the frequency bandwidth of LTE is 10 MHz and the center frequency of the transmission signal Tx1 is f1=1539 MHz. It is also assumed that the frequency bandwidth of LTE is 20 MHz and the center frequency of the transmission signal Tx2 is f2=1523 MHz. In this case, third-order intermodulation distortions occur at the following center frequencies/bandwidths.

1539 MHz/27 MHz

1523 MHz/36 MHz

1507 MHz/45 MHz

1555 MHz/36 MHz

1539 MHz/45 MHz

1523 MHz/54 MHz

These are values calculated by the following calculation formulas.

1539 [MHz]=f1*f1*conj(f1)

1523 [MHz]=f1*f2*conj(f1)

1507 [MHz]=f2*f2*conj(f1)

1555 [MHz]=f1*f1*conj(f2)

1539 [MHz]=f1*f2*conj(f2)

1523 [MHz]=f2*f2*conj(f2)

That is, assuming that the center frequency of the received signal Rx is 1509 MHz, third-order intermodulation distortions of f1*f2*conj(f1), f2*f2*conj(f1), and f2*f2*conj(f2) overlap the received band, causing PIM. In this case, the influence rates IR for the third-order intermodulation distortions of f1*f2*conj(f1), f2*f2*conj(f1), and f2*f2*conj(f2) are 37.8, 92.6, and 55.6%, respectively.

The order of priority is set in order from the highest influence rate IR. In this case, first, an IM signal having a first priority (an IM signal with an influence rate IR of 92.6%) out of a plurality of IM signals added to the received signal Rx is cancelled by a cancellation signal C generated by equation (4). Next, an IM signal having a second priority (an IM signal with an influence rate IR of 55.6%) out of the plurality of IM signals added to the received signal Rx is cancelled by a cancellation signal C generated by equation (5). Next, an IM signal having a third priority (an IM signal with an influence rate IR of 37.8%) out of the plurality of IM signals added to the received signal Rx is cancelled by a cancellation signal C generated by equation (3).

In such a manner, in the wireless communication system according to the first embodiment, the order of priority is seen by using the influence rates IR described above. Accordingly, in the wireless communication system according to the first embodiment, an IM signal with a high influence rate IR takes priority to be cancelled, thereby making it possible to improve the processing time taken to cancel PIM.

Distortion Cancellation Process

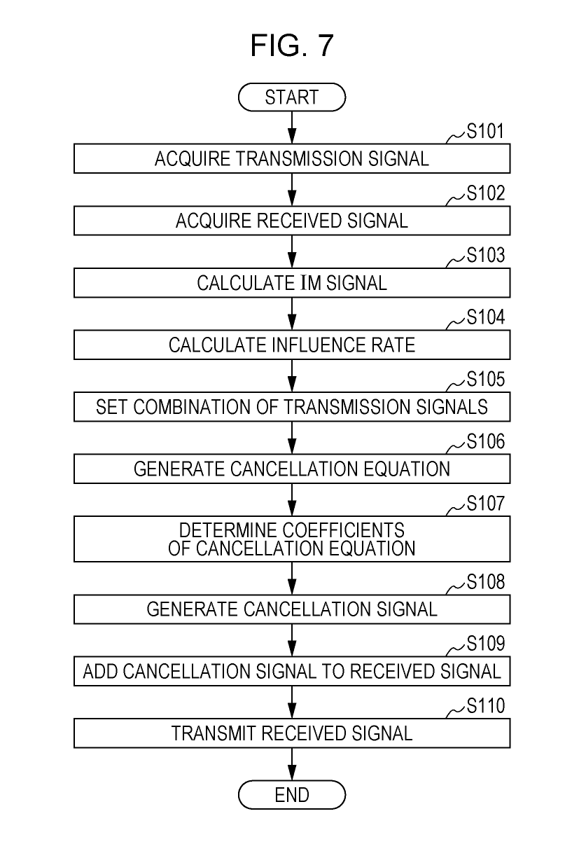

FIG. 7 is a flowchart illustrating an example of a distortion cancellation process of the cancellation apparatus 200 of the wireless communication system according to the first embodiment.

The transmission signals Tx1 and Tx2 transmitted from the REC 100 are acquired via the interface 210 by the transmission signal acquisition unit 221 of the processor 220 (operation S101). Note that the transmission signals acquired by the transmission signal acquisition unit 221 are transmitted from the transmission signal transmitting unit 222 via the interface 240 to the REs 300a and 300b. In contrast, the received signals Rx received by the RE 300a and RE 300b are acquired via the interface 240 by the received signal acquisition unit 223 of the processor 220 (operation S102). Intermodulation signals generated by intermodulation of the transmission signals Tx1 and Tx2 are added to each of the received signals Rx at the RE 300a and RE 300b.

Upon acquisition of the transmission signals and received signals, a plurality of IM signals are calculated from the transmission signals Tx1 and Tx2 by the influence rate calculation unit 251 of the processor 220 (operation S103). Thereafter, the magnitudes of signal levels of the plurality of IM signals are estimated and the influence rates IR of PIM on the received signal Rx are calculated by the influence rate calculation unit 251 (operation S104). The influence rate IR is calculated by the above equation (2). Then, based on the influence rates IR, a combination of the transmission signals Tx1 and Tx2 for generating a plurality of IM signals that overlap the received signal Rx is set in the cancellation equation generation units 252 by the influence rate calculation unit 251 (operation S105).

Thereafter, in the cancellation signal generation unit 254, an IM signal is generated from the transmission signals Tx1 and Tx2 by each cancellation equation generation unit 252 in which the setting has been performed by the influence rate calculation unit 251. In addition, a cancellation equation for generating a cancellation signal C from the IM signal is generated by each cancellation equation generation unit 252 (operation S106). That is, the above equations (3) to (5) are generated. Then, for example, a least square method, correlation detection, or the like using the received signal Rx is performed by the coefficient generation unit 253, thereby determining coefficients of cancelation equations (operation S107). Here, the coefficients p1 to p3 respectively included in the above equations (3) to (5) are determined by the coefficient generation unit 253.

If the coefficients are determined, it becomes possible to generate cancellation signals C by using cancellation equations, and therefore a cancellation signal C corresponding to an IM signal is generated by each cancellation equation generation unit 252 (operation S108). The generated cancellation signals C are output to the cancellation unit 224 in such a manner that an IM signal with a high influence rate IR takes priority. Here, the cancellation signal C generated by equation (4) is first output to the cancellation unit 224. Next, the cancellation signal C generated by equation (5) is output to the cancellation unit 224, and then the cancellation signal C generated by equation (3) is output to the cancellation unit 224.

The cancellation signals C are then combined with (added to) the received signal Rx by the cancellation unit 224 (operation S109), and thus the plurality of IM signals added to the received signal Rx are cancelled. That is, the cancellation signal C generated by the above equation (4) is added to the received signal Rx, and thus an intermodulation distortion of f2*f2*conj(f1) added to the received signal Rx is cancelled. Next, the cancellation signal C generated by the above equation (5) is added to the received signal Rx, and thus an intermodulation distortion of f2*f2*conj(f2) added to the received signal Rx is cancelled. Next, the cancellation signal C generated by the above equation (3) is added to the received signal Rx, and thus an intermodulation distortion of f1*f2*conj(f1) added to the received signal Rx is cancelled.

The received signal Rx resulting after the plurality of IM signals have been cancelled is transmitted via the interface 210 to the REC 100 by the received signal transmitting unit 225 (operation S110).

As disclosed in the preceding description, a distortion cancellation apparatus (the cancellation apparatus 200) of the wireless communication system according to the first embodiment includes the transmission signal acquisition unit 221, the received signal acquisition unit 223, the cancellation signal generation unit 254, the influence rate calculation unit 251, and the cancellation unit 224. The transmission signal acquisition unit 221 acquires the plurality of transmission signals Tx1 and Tx2 wirelessly transmitted at different frequencies. The received signal acquisition unit 223 acquires a received signal Rx to which a plurality of intermodulation signals (IM signals) generated by the plurality of transmission signals Tx1 and Tx2 are added. The cancellation signal generation unit 254 generates a plurality of cancellation signals C respectively corresponding to the plurality of IM signals added to the received signal Rx by using an arithmetic expression including the plurality of transmission signals Tx1 and Tx2 and the received signal Rx. The influence rate calculation unit 251 calculates the influence rate IR indicating the magnitude of the signal level of each of the plurality of IM signals within the band of the received signal Rx. That is, the influence rate calculation unit 251 calculates the influence rate IR of an intermodulation distortion (PIM) on the received signal Rx. The influence rates IR are calculated by the above equation (2). Based on the plurality of cancellation signals C, the cancellation unit 224 first cancels an IM signal with a high influence rate IR out of the plurality of IM signals added to the received signal Rx. According to the wireless communication system according to the first embodiment, an IM signal with a high influence rate IR takes priority to be cancelled, thereby making it possible to improve the processing time taken to cancel PIM.

Note that an IM signal with a high influence rate IR out of a plurality of IM signals added to the received signal Rx is cancelled first in the first embodiment; however, embodiments are not limited to this. In a second embodiment, IM signals with influence rates IR less than or equal to a threshold are not cancelled. An embodiment in this case will be described as the second embodiment below. Note that, in the second embodiment, the same configurations as in the first embodiment are denoted by the same reference numerals, and thus the overlapping configurations and operations are not described.

### Second Embodiment

### Example

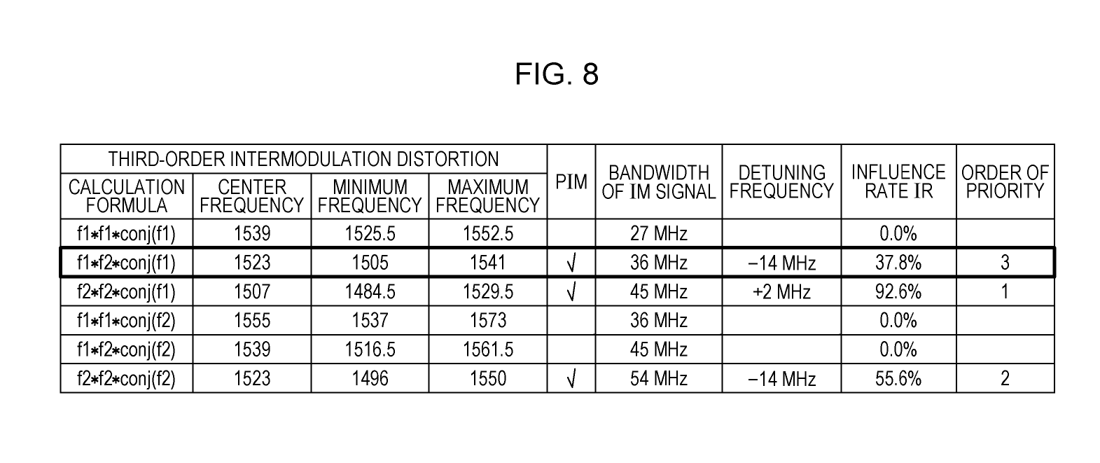

Here, influence rates IR and priorities thereof will be described by using an example. FIG. 8 is a diagram illustrating an example of the center frequency, the minimum frequency, and the maximum frequency of each third-order intermodulation distortion, the presence or absence of occurrence of PIM, the bandwidth of an IM signal, the detuning frequency, the influence rate IR, and the order of priority in a wireless communication system according to the second embodiment. In FIG. 8, an IM signal with an influence rate IR of 37.8% is highlighted, which differs from in FIG. 6.

For example, it is assumed that the threshold of the influence rate IR is set to 50%. Here, inhibiting IM signals with influence rates IR less than or equal to 50% from being cancelled makes it possible to reduce the number of the cancellation equation generation units 252 for which the influence rate calculation unit 251 performs setting.

Distortion Cancellation Process

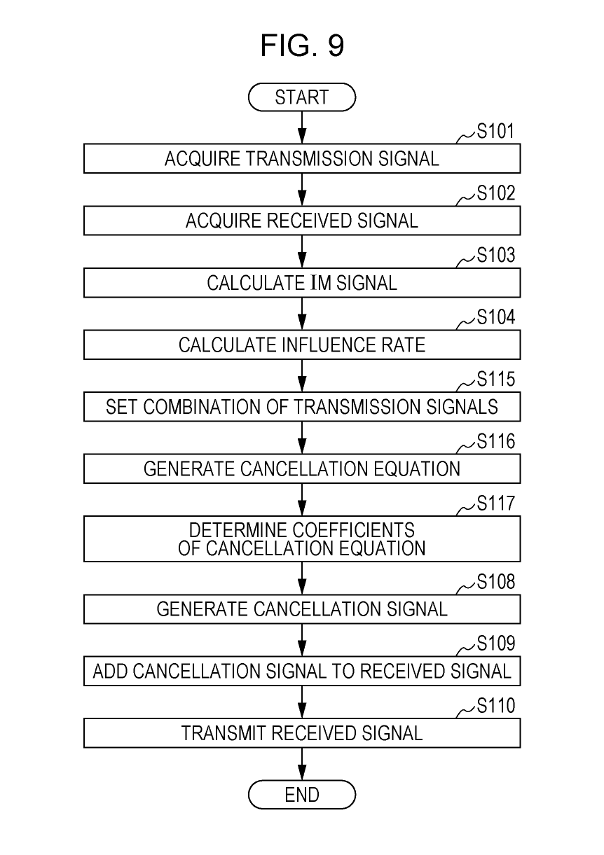

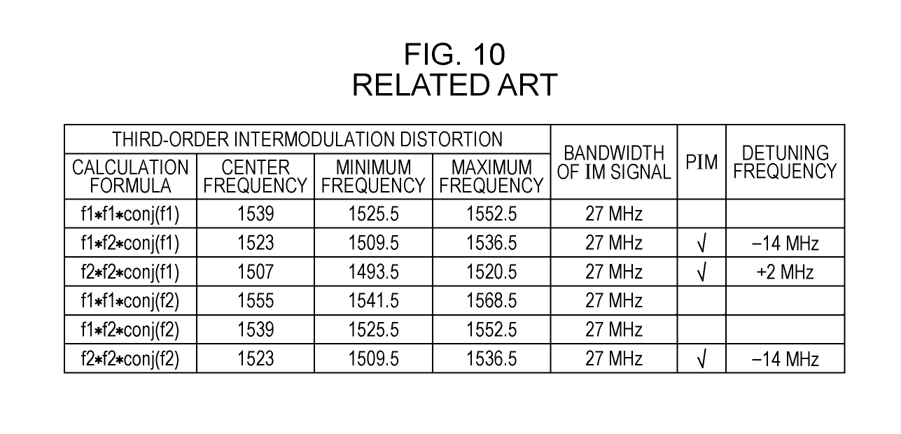

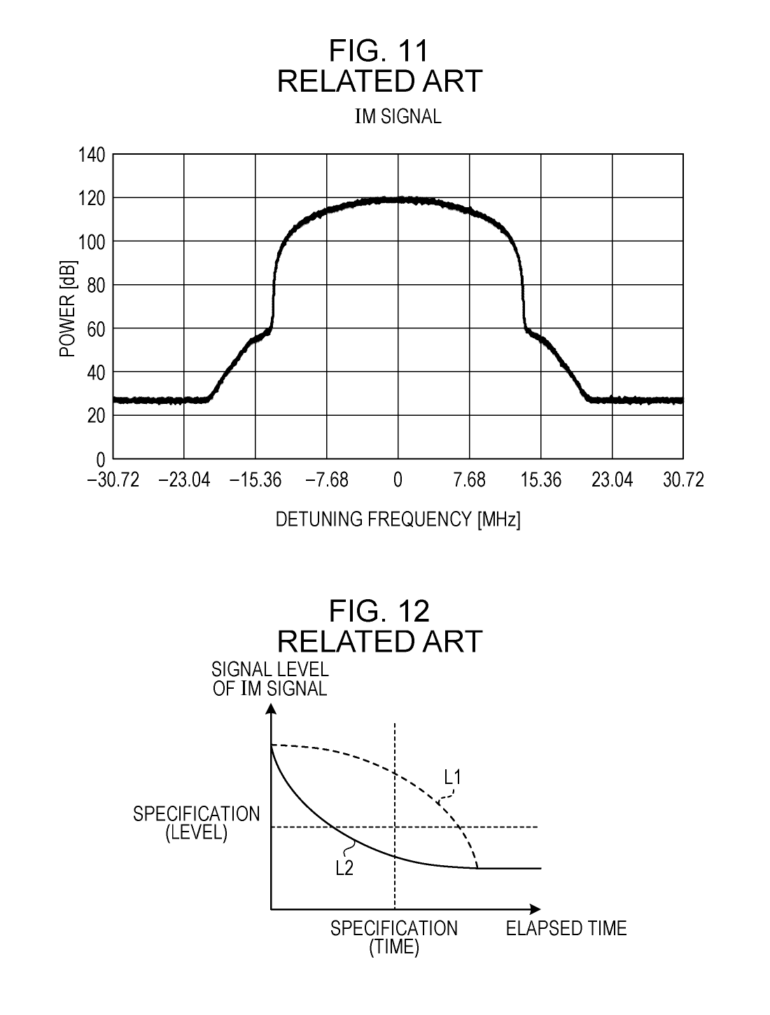

FIG. 9 is a flowchart illustrating an example of a distortion cancellation process of the cancellation apparatus 200 of the wireless communication system according to the second embodiment. With reference to FIG. 9, operations S115 to S117 are performed instead of operations S105 to S107 illustrated in FIG. 7.

The transmission signals Tx1 and Tx2 transmitted from the REC 100 are acquired via the interface 210 by the transmission signal acquisition unit 221 of the processor 220 (operation S101). Note that the transmission signals acquired by the transmission signal acquisition unit 221 are transmitted from the transmission signal transmitting unit 222 via the interface 240 to the REs 300a and 300b. In contrast, the received signals Rx received by the RE 300a and RE 300b are acquired via the interface 240 by the received signal acquisition unit 223 of the processor 220 (operation S102). Intermodulation signals generated by intermodulation of the transmission signals Tx1 and Tx2 are added to each of the received signals Rx at the RE 300a and the RE 300b.

Upon acquisition of the transmission signals and received signals, a plurality of IM signals are calculated from the transmission signals Tx1 and Tx2 by the influence rate calculation unit 251 of the processor 220 (operation S103). Thereafter, the magnitudes of signal levels of the plurality of IM signals are estimated and the influence rates IR of PIM on the received signal Rx are calculated by the influence rate calculation unit 251 (operation S104). The influence rates IR are calculated by the above equation (2). Then, based on the influence rates IR, a combination of the transmission signals Tx1 and Tx2 for generating a plurality of IM signals that overlap the received signal Rx is set in the cancellation equation generation units 252 by the influence rate calculation unit 251 (operation S115). In the second embodiment, the IM signal with an influence rate of 37.8% is excluded. That is, the above equation (3) is excluded.

Thereafter, in the cancellation signal generation unit 254, an IM signal is generated from the transmission signals Tx1 and Tx2 by each cancellation equation generation unit 252 in which the setting has been performed by the influence rate calculation unit 251. In addition, a cancellation equation for generating a cancellation signal C from the IM signal is generated by each cancellation equation generation unit 252 (operation S116). That is, the above equations (4) and (5) are generated. Then, for example, a least square method, correlation detection, or the like using the received signal Rx is performed by the coefficient generation unit 253, thereby determining the coefficients of cancellation equations (operation S117). Here, the coefficients p2 and p3 respectively included in the above equations (4) and (5) are determined by the coefficient generation unit 253.

If the coefficients are determined, it becomes possible to generate cancellation signals C by using cancellation equations, and therefore a cancellation signal C corresponding to an IM signal is generated by each cancellation equation generation unit 252 (operation S108). The generated cancellation signals C are output to the cancellation unit 224 in such a manner that an IM signal with a high influence rate IR takes priority. Here, the cancellation signal C generated by equation (4) is first output to the cancellation unit 224. Next, the cancellation signal C generated by equation (5) is output to the cancellation unit 224.

The cancellation signals C are then combined with (added to) the received signal Rx by the cancellation unit 224 (operation S109), and thus the plurality of IM signals added to the received signal Rx are cancelled. That is, the cancellation signal C generated by the above equation (4) is added to the received signal Rx, and thus an intermodulation distortion of f2*f2*conj(f1) added to the received signal Rx is cancelled. Next, the cancellation signal C generated by the above equation (5) is added to the received signal Rx, and thus an intermodulation distortion of f2*f2*conj(f2) added to the received signal Rx is cancelled.

The received signal Rx resulting after the plurality of IM signals have been cancelled is transmitted via the interface 210 to the REC 100 by the received signal transmitting unit 225 (operation S110).

As disclosed in the preceding description, in a distortion cancellation apparatus (the cancellation apparatus 200) of a wireless communication system according to the second embodiment, the cancellation unit 224 performs the processing described below in addition to the processing in the first embodiment. Specifically, based on a plurality of cancellation signals C, the cancellation unit 224 first cancels an IM signal with a high influence rate IR out of a plurality of intermodulation signals (IM signals) added to the received signal Rx. Here, the cancellation unit 224 cancels IM signals with influence rates IR larger than a threshold out of the plurality of IM signals added to the received signal Rx. That is, in the wireless communication system according to the second embodiment, IM signals with influence rates IR less than or equal to the threshold are not cancelled. Thus, in the wireless communication system according to the second embodiment, the cancellation equation generation units 252 are not assigned to IM signals that have not to be cancelled, which may result in a reduction in the circuit scale in addition to the advantages of the first embodiment.

Note that distortion cancellation processing is performed by the processor 220 of the cancellation apparatus 200 in each embodiment described above; however, the cancellation apparatus 200 does not have to be arranged as an independent apparatus. That is, the functions of the processor 220 of the cancellation apparatus 200 may be included in, for example, the processor 110 of the REC 100. In addition, a processor having functions equivalent to those of the processor 220 may be included in the RE 300a or the RE 300b.

The distortion cancellation processing described in each of the above embodiments may be described as a computer-executable program. In this case, the program may be stored on a computer-readable recording medium and be introduced to a computer. As the computer-readable recording medium, a portable recording medium such as, for example, compact disk read-only memory (CD-ROM), a digital versatile disc (DVD), or universal serial bus (USB) memory or semiconductor memory such as, for example, flash memory is listed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A distortion cancellation apparatus comprising:
a memory; and
a processor coupled to the memory and the processor configured to:
acquire a plurality of transmission signals to be wirelessly transmitted at different frequencies,
acquire a received signal to which a plurality of intermodulation signals generated by the plurality of transmission signals are added,
generate a plurality of cancellation signals respectively corresponding to the plurality of intermodulation signals added to the received signal by using an arithmetic expression including the plurality of transmission signals and the received signal,
calculate an influence rate indicating a magnitude of a signal level of each of the plurality of intermodulation signals within a band of the received signal, and
first cancel an intermodulation signal out of the plurality of intermodulation signals added to the received signal wherein the influence rate of the intermodulation signal first canceled is high out of the plurality of intermodulation signals added to the received signal, based on the plurality of cancellation signals.

2. The distortion cancellation apparatus according to claim 1, wherein, assuming that a bandwidth of the intermodulation signal is B_{IM}, a bandwidth of the received signal is B_{RX}, a center frequency of the intermodulation signal is f_{IM}, a center frequency of a received signal Rx is f_{RX}, and the influence rate is IR, the influence rate is expressed by
IR={(B_{IM}+B_{RX})/2−abs(f_{Rx}−f_{IM})}/{(B_{IM}+B_{RX})/2}.

3. The distortion cancellation apparatus according to claim 1, wherein the processor is configured to cancel an intermodulation signal out of the plurality of intermodulation signals added to the received signal wherein the influence rate of the intermodulation signal out of the plurality of intermodulation signals added to the received signal is higher than a threshold.

4. A distortion cancellation method comprising:
acquiring a plurality of transmission signals wirelessly transmitted at different frequencies;
acquiring a received signal to which a plurality of intermodulation signals generated by the plurality of transmission signals are added;
generating a plurality of cancellation signals respectively corresponding to the plurality of intermodulation signals added to the received signal by using an arithmetic expression including the plurality of transmission signals and the received signal;
calculating an influence rate indicating a magnitude of a signal level of each of the plurality of intermodulation signals within a band of the received signal; and
first cancelling, based on the plurality of cancellation signals, an intermodulation signal out of the plurality of intermodulation signals added to the received signal wherein the influence rate of the intermodulation signal out of the plurality of intermodulation signals added to the received signal is high, by a processor.

5. The distortion cancellation method according to claim 4, wherein, assuming that a bandwidth of the intermodulation signal is B_{IM}, a bandwidth of the received signal is B_{RX}, a center frequency of the intermodulation signal is f_{IM}, a center frequency of a received signal Rx is f_{RX}, and the influence rate is IR, the influence rate is expressed by
IR={(B_{IM}+B_{RX})/2−abs(f_{Rx}−f_{IM})}/{(B_{IM}+B_{RX})/2}.

6. The distortion cancellation method according to claim 4, wherein the first cancelling cancels an intermodulation signal out of the plurality of intermodulation signals added to the received signal wherein the influence rate of the intermodulation signal out of the plurality of intermodulation signals added to the received signal is higher than a threshold.

7. A distortion cancellation apparatus comprising:
a memory; and
a processor coupled to the memory and the processor configured to:
acquire a plurality of transmission signals to be wirelessly transmitted at different frequencies,
acquire a received signal to which a plurality of intermodulation signals generated by the plurality of transmission signals are added,
generate a plurality of cancellation signals respectively corresponding to the plurality of intermodulation signals added to the received signal by using an arithmetic expression including the plurality of transmission signals and the received signal,
calculate an influence rate indicating a magnitude of a signal level of each of the plurality of intermodulation signals within a band of the received signal,
prioritize cancellation of at least one of the plurality of intermodulation signals based on the calculated influence rate of each of the plurality of intermodulation signals, and
cancel the at least one intermodulation signal out of the plurality of intermodulation signals added to the received signal, based on the prioritizing.

8. The distortion cancellation apparatus according to claim 7, wherein, assuming that a bandwidth of the intermodulation signal is B_{IM}, a bandwidth of the received signal is B_{RX}, a center frequency of the intermodulation signal is f_{IM}, a center frequency of a received signal Rx is f_{RX}, and the influence rate is IR, the influence rate is expressed by
IR={(B_{IM}+B_{RX})/2−abs(f_{Rx}−f_{IM})}/{(B_{IM}+B_{RX})/2}.

9. The distortion cancellation apparatus according to claim 7, wherein the processor is configured to cancel an intermodulation signal out of the plurality of intermodulation signals added to the received signal wherein the influence rate of the intermodulation signal out of the plurality of intermodulation signals added to the received signal is higher than a threshold.
